(19) United States
(12) Patent Application Publication
(10) Pub. No.: US 2008/0052147 A1
(43) Pub. Date: Feb. 28, 2008

(54) SYSTEM AND METHOD FOR INFLUENCING PUBLIC OPINION

(76) Inventors: Eran Reshef, Tel-Aviv (IL); Amir Hirsh, Tel-Aviv (IL)

Correspondence Address: DREIER LLP, 499 PARK AVE, NEW YORK, NY, 10022, US

(21) Appl. No.: 11/778,834

(22) Filed: Jul. 17, 2007

Related U.S. Application Data
(60) Provisional application No. 60/831,886, filed on Jul. 18, 2006.

(51) Int. Cl. G06F 17/30

(52) U.S. Cl. 705/10

(57) ABSTRACT

A method and system for influencing public opinion are provided for influencing public opinion using a community of members. Methodologies and/or techniques are included to collect Influence Points; analyze Influence Points to find URLs of Interest (UOI) where the community needs act; plan effective campaigns; distribute tasks derived from campaigns to community members. The methodologies and/or techniques may also include monitoring the progress of campaigns. One campaign mechanism includes real-time desktop or browser add-on alerts sent to some or all community members, asking the members to voice their opinions at a selected UOI. Other campaign mechanism includes asking all or some of the members to act in a way that when measured by an outside agency will show a positive trend

### PRIORITY CLAIM

The present application claims the benefit of pending U.S. Provisional Application Ser. No. 60/831,886, entitled “SYSTEM AND METHOD FOR INFLUENCING PUBLIC OPINION”, filed on Jul. 18, 2006, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention is directed to computer networks, and more particularly to a system and method for influencing public opinion using computer networks.

### BACKGROUND OF THE INVENTION

Influencing public opinion using grassroots campaigns is an old tradition, including many activities, such as: door-to-door, also known as canvassing, phone banking, house parties, meetings, putting up posters, talking with pedestrians on the street (often involving informational clipboards), gathering signatures for petitions, setting up information tables, raising money from many small donors for political advertising or campaigns, organizing large demonstrations, asking individuals to manually write letters to media outlets and government officials, and “get out the vote” activities which includes the practices of reminding people to vote and may include transporting them to polling places.

The Internet has helped many organizations better organize grassroots campaigns, mostly using email. However, email is far from being an ideal communication platform for grassroots campaigns.

Many users are reluctant to provide their real email addresses for fear of spam, and provide either false or throw away accounts. Even those who do provide real addresses, tend to use spam filters that sharply reduce the deliverability rates of any call for action. And on top of all that, a typical user has dozens of emails it has to read every day, so a call for action is not likely to receive the attention its sender would have liked it to receive.

Many grassroots campaigns are executed in the Internet. Due to the Internet nature, time is of the essence. For example, the first comments made to a web log (blog) item are usually the ones who are read by subsequent users. A comment posted a day after the blog item was posted are usually read by very few people. Email cannot provide the near real time abilities required for a truly effective campaign.

Email has many other drawbacks for managing grassroots campaigns. Email does not allow an organizer of a campaign to have an effective two-way communication channel with individual members, nor does it easily provide for monitoring of campaign progress.

### SUMMARY OF THE INVENTION

A method and system for influencing public opinion provides for influencing public opinion using a community of members. Methodologies and/or techniques are included to collect Influence Points; analyze Influence Points to find URLs of Interest (UOI) where the community needs to act; plan effective campaigns; and distribute tasks derived from campaigns to community members. The system and method may also include monitoring the progress of these campaigns.

The invention collects Influence Points, such as online articles from major newspapers, articles by world leaders, highly-read blogs, lists of popular searches, popular books, online surveys, and content of top journalists, by way of example. The collection can be done in multiple ways, such as manually by community members, via RSS, via search engines, or any other suitable means.

The invention analyzes the Influence Points, rates and extracts UOIs. For example, UOI of a blog item is its talkback form, UOI of a political figure is his or her email address and UOI of a popular book is its online review form.

One type of a method for influencing public opinion includes real-time alerts sent to some or all community members, asking the members to write their own opinions at a selected UOI, such as a talkback section of a news article. This will create a positive influence at the Influence Point that owns said UOI.

Another example of mechanism for influencing public opinion includes a script or sequence of executable commands that are forwarded to the members, and given their consent, cause the members' computers to automatically voice a pre-defined opinion (or member-customized opinion) at the selected UOI thereby simplifying the manual operations required to voice the opinion.

Another public opinion influencing mechanism can include an alert to members to participate in an online survey, shifting the survey results to a desired direction.

Another public opinion influencing mechanism can include an alert to members to vote for a UOI in social bookmarking sites to promote the UOI and influence the social bookmarking community opinion on that subject.

Another public opinion influencing mechanism can include methodologies and/or techniques for instructing all or some of the members to act in a way that when measured by an outside agency will show a positive trend. For example, with many members searching for positive terms in search engines, the “top searches” page will start to include the positive terms. Another example is having many members browsing a positive news story, making the “popular stories” page including the positive news item.

The public opinion influencing method and system can be offered to organizations for a fee. It can also be offered for free in exchange for displaying advertisement to individual members. It can also be offered for free to non-commercial individuals or not for profit organizations who wish to promote their agendas.

Other business model and technical aspects would become apparent to those skilled in the relevant art(s) in view of the teachings of the present disclosure. Additional aspects of the present invention would be apparent in view of the description that follows.

### BRIEF DESCRIPTION OF THE DRAWINGS

The foregoing and other aspects of the invention will become more apparent from the following description of illustrative embodiments thereof and the accompanying drawings, which illustrate, by way of example, the principles of the invention. In the drawings:

FIG. 1 illustrates one embodiment of a public opinion influencing system

FIG. 2 illustrates the components of one embodiment of a public opinion influencing engine and its internal data flow;

FIG. 3 illustrates the process of one embodiment of influencing public opinion using a public opinion influencing system

FIGS. 4a-4d illustrate an example of a member reporting a news article.

FIG. 5 illustrates an example of a member reporting a survey.

FIG. 6 illustrates an example of a member reporting a blog item.

FIG. 7 illustrates an example of a member reporting a political leader's site.

FIG. 8 illustrates an example of the user interface for planning campaigns;

FIGS. 9a-9f illustrate examples of a user alerted to voice her opinion via a desktop alert or via a browser add-on alert.

### DETAILED DESCRIPTION

The present invention will now be described in detail with reference to the drawings, which are provided as illustrative examples of the invention so as to enable those skilled in the relevant art(s) to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

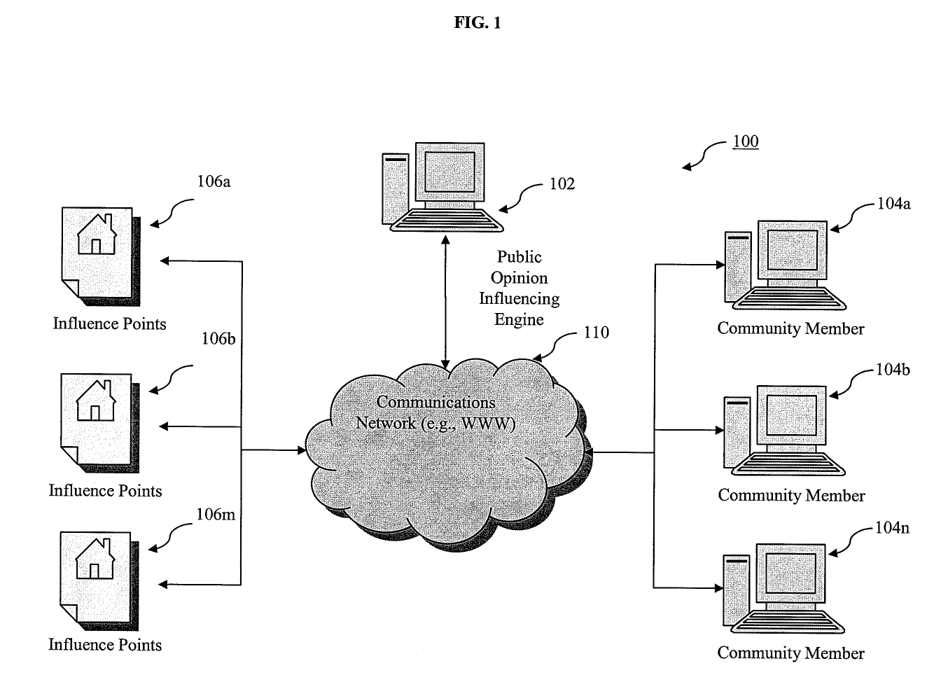

FIG. 1 illustrates a system 100 that includes a public opinion influencing engine 102, a plurality of community members 104a-104n (where n may be any suitable integer), a plurality of Influence Points 106a-106m (where m may be any suitable integer), and a communications network 110. A public opinion influencing system 100 is configured to generate a positive public opinion by modifying opinion of the Influence Points 106a-106n.

As described in further detail below, the public opinion influencing engine 102 may be one or more processing devices or systems operative to perform various computing operations allowing for the management of techniques for influencing public opinion. Community members 104a-104n may be users having access to a local computing system and in communication with the engine 102, where the user and/or the user's local computing devices can be utilized to perform various operations relating to determining and/or influencing public opinion. Community members 104a-104n may use a wired and/or wireless personal computer, personal digital assistant (PDA), enhanced telephone, personal television, or other data processing device linked to communications network 110 to communicate with the public opinion influencing engine 102.

As explained in greater detail below, the public opinion influencing engine 102 provides an operations center that includes a combination of manual and automated methodologies and/or techniques that are used to shape the opinions expressed by the Influence Points 106a-106m. The public opinion influencing engine 102 can be implemented to initiate and manage multiple campaigns aimed at creating positive public opinion.

For example, campaigns may alert one or more community members 104a-104n to leave positive comments in an influential blog, write talkbacks for an article in a key newspaper, send emails to an important political leader, submit a feedback in the contact-us form of a company, send a fax to journalist, write a review for a book, participate in an online survey or vote in a social bookmarking site.

In another embodiment of the invention, campaigns may alert members to act in a way that the combined effect of all members will have a positive impact on public opinion, such as searching for a certain term in a search engine, thus making it a popular search term, downloading an application from download sites thus making it a popular file, marking a story as “cool” in shared-editorial sites (e.g., Digg.com) thus raising the popularity of a story, browsing a news article thus making it a popular article.

Instead of sending an alert, given the consent of the members, the opinion influencing engine 102 may send a series of commands (script) to the computing devices of community members 104a-104n making their computing devices generate the same effect as if each community member performed the action detailed in the alert.

A public opinion influencing engine 102 can be implemented via one or more servers, with each server being one or more computers providing various shared resources with each other and to other system components. The shared resources include files for programs, web pages, databases and libraries; output devices, such as, printers, plotters, display monitors and facsimile machines; communications devices, such as modems and Internet access facilities; and other peripherals such as scanners, or the like. The communications devices can support wired or wireless communications, including satellite, terrestrial (fiber optic, copper, coaxial, and the like), radio, microwave, free-space optics, and/or any other form or method of transmission.

The server hosting a public opinion influencing engine 102 can be configured to support the standard Internet Protocol (IP) developed to govern communications over public and private Internet backbones. The protocol is defined in Internet Standard (STD) 5, Request for Comments (RFC) 791 (Internet Architecture Board). The server also supports transport protocols, such as, Transmission Control Protocol (TCP), User Datagram Protocol (UDP), Real Time Transport Protocol (RTP), or Resource Reservation Protocol (RSVP). The transport protocols support various types of data transmission standards, such as File Transfer Protocol (FTP), Hypertext Transfer Protocol (HTTP), Secure Hypertext Transfer Protocol (HTTPS), Simple Network Management Protocol (SNMP), Network Time Protocol (NTP), or the like.

Communications network 110 provides a transmission medium for communicating among the system components. Communications network 110 includes a wired and/or wireless local area network (LAN), wide area network (WAN), or metropolitan area network (MAN), such as an organization's intranet, a local internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Communications network 110 includes wired, wireless, or both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

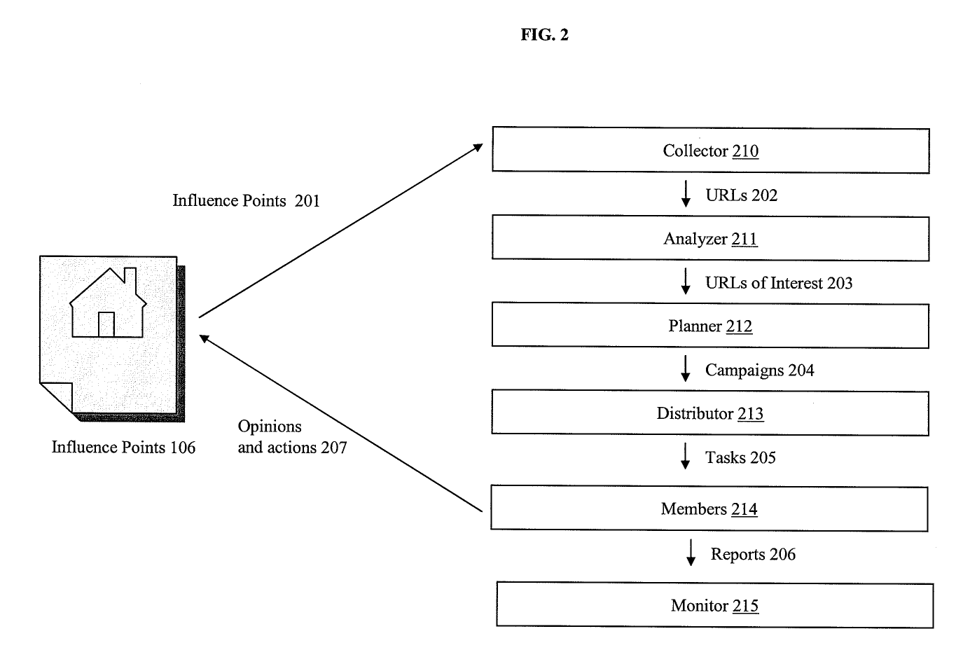

FIG. 2 illustrates an embodiment of the public opinion influencing engine 102, also referred to by the acronym POSE. However, the present invention is not implicitly or explicitly limited to such an embodiment, and various alternative models and organizations would become apparent to those skilled in the relevant art(s) after being taught by the present example. The components of FIG. 2 can be implemented using a combination of computer hardware, firmware, and software, using engineering design techniques and network protocols that are guided by the principles of the present invention as would become apparent from the detailed descriptions herein. For example, all components can be implemented as software components running on top of standard personal computers running the Windows® operating systems available from Microsoft Corporation (Redmond, Wash.).

The components of POSE 102 include a Collector subsystem 210, an Analyzer subsystem 211, a Planner subsystem 212, a Distributor subsystem 213, a plurality of Community Members and their computing devices 214, a monitoring subsystem 215.

Collector 210 gathers information about Influence Points and generates a list of URLs for Analyzer 211. Collector 210 can gather information from multiple sources. For example, Collector 210 can receive reports from community members 104a-104n, from automated searches or from RSS feeds.

Analyzer 211 reviews incoming URLs 202 to determine URLs of Interest 203 out of all raw URLs 202. For example, Analyzer 211 can identify URLs of Interest 203 by crawling web sites pointed to by URLs 202 and identifying exact locations of feedback forms.

Analyzer 211 can also determine URLs of Interest 203 by using information gathered on previously analyzed URLs on the same site. For example, if a newspaper site was analyzed already, it is most likely that all articles published on the same site will have the same feedback mechanism. In another embodiment, the URL of Interest may relate to user-generated content or system implemented content, such as for example a user uploading an article to a particular Internet location. For example, the article may include one or more videos, one or more photos, a blog entry, a written article, an editorial article, or any other suitable type of posted content.

Analyzer 211 can also receive manual input to determine which of the raw URLs 202 are URLs of Interest 203, or even import a list of URLs of Interest 203 from an external source.

Planner 212 provides centralized control for planning optimized and effective campaigns. Planner 212 prioritizes all URLs of Interest 203, selects the appropriate campaign type for each URL of Interest 203 and assigns the number of community members 104 that will participate in each campaign. The result is a list of optimized campaigns 204 that best leverage the community power to create positive public opinion.

Planner 212 may also create new articles in web sites to support the URLs of Interest 203 such as creating a new Digg story in the site Digg.com to be then promoted by community members 104.

In an embodiment, Planner 212 is a decision support system for a human analyst. Planner 212 presents a list of URLs of Interest 203 pre-prioritized according to previously entered rules. The human analyst selects one or more URLs of Interest, and either approves or modifies the pre-assigned campaign type and number of participating members that were selected by Planner 212 according to previously entered rules. The human analyst may also create stories that reference the URLs of Interest and/or upload other content to story-editing sites such as Digg.com, and then direct community members to those sites.

In another embodiment, Planner 212 is an optimizer that generates the most efficient (in terms of community members) and most effective (in terms of public opinion influencing effect) series of campaigns. For example, the planner 212 may perform the optimization by measuring, from previous campaigns, the conversion ratio between the number of members receiving a certain type of task (such as voting for an article) and the number of members actually performing the task, and taking into account the number of votes required to promote the article effectively. Planner 212 may then determine the actual number of members required to generate the desired effect, and also to predict the chances of success.

Planner 212 may include a graphical user interface (GUI) whose screens provide the analysts with multiple views into the URL of Interest 203, such as by importance, by campaign type, etc.

One type of campaign includes having multiple members write their own opinion at recommended newspapers and blogs, based on talking points suggested by the Public Opinion Influencing Engine.

Another type of campaign includes a script or sequence of executable commands that are forwarded to the members, and given the members consent, cause the members' computers to automatically connect via HTTP, SMTP or the like to a web site, such as a newspaper, a blog or a political leader's site, and submit a pre-defined text provided by the Public Opinion Influencing Engine or a customized text written by the member.

Another type of campaign consists of members voting in an online survey according to recommendations suggested by the Public Opinion Influencing Engine, thus shifting the result of the survey to a move favorable direction.

Another type of campaign is instructing all or some of the members to act in a way that when measured and reported by an external agency will show a positive trend. For example, with many members downloading software that provides a positive angle on an important issues (e.g., a computer game about the war in Iraq), the “most downloaded” page will include the computer game. Another example is having many members email a positive news story, making the “most emailed storied” page include the positive news item.

Another type of campaign is to provide information about an event or action that takes place in real life. For example, invite members to participate in a real-life demonstration. Tasks may also include instructions for specific user activity, such as instructions to write a representative, write and send electronic messages, e.g. an email, an SMS, etc., or instructions to attend a demonstration, as opposed to other tasks that may include invitations.

Another type of campaign is to provide information that is of interest to community members, and is likely to be used by members in future campaigns, but does not require immediate action. For example, invite members to visit a web site that offers relevant research material.

It should be understood that the campaign types described herein are to be implemented in compliance with all governing laws, regulations and terms of services.

Distributor 213 provides a distribution service of campaigns to community members 214. In one embodiment, each member's computing device polls at regular intervals the Distributor 213 over the communication network 110. At each poll, Distributor 213 checks whether that member 214 should participate in a campaign. If so, Distributor 213 hands off a task 205 the member's computing device. Members 214 participate in Campaigns 204 by fulfilling Tasks 205, voicing their opinions or performing requested actions at influence points 106.

For example, a task may be to show a desktop alert asking the member to perform a certain action, such as participating in an online survey or sending a comment to a blog item. In another embodiment, given a prior consent from the member the task may be a series of automated actions (script) that is executed by the member's computing device as if the member itself performed the action.

Monitor 215 receives reports 206 from members 214, either automatically or manually. Monitor 215 may also monitor various Web sites and/or specifically the Influence Points 201, either automatically or manually. For example, the monitor 215 may directly access a particular website to determine the effectiveness of the campaign, such as accessing a web site to determine the popularity ranking of a particular article while the campaign is active. Techniques of monitoring the campaign may include looking at a ranking factor, number of votes on a survery, comments on an article or blog, or any other suitable measurement or metric as recognized by one skilled in the art. In one embodiment, reports 206 provide an indication whether a task 205 was completed successfully. All reports 206 are analyzed and integrated by Monitor 215 to measure the effectiveness of campaigns 204 and assist Planner 212 in planning future campaigns 204. For example, if only half of the members 214 carried on their assigned tasks 205, Planner 212 may elect to assign twice the number of members required in future campaigns to ensure their success. In another example, Monitor 215 polls the news site front page, and if the promoted story reached it, Distributor 213 might choose to stop sending tasks 205 to members 214, as the goal has been reached.

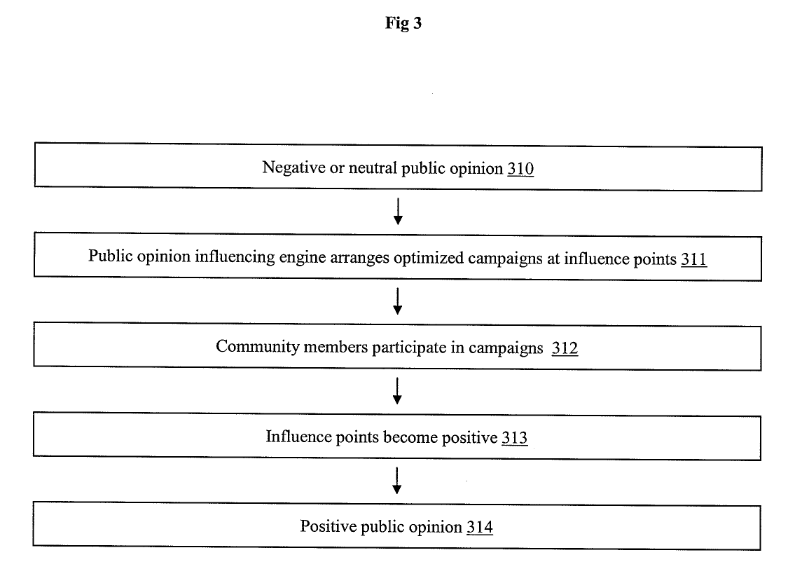

FIG. 3 shows an example of influencing public opinion using a public opinion influencing system. At step 310, the public opinion on a certain issue is negative or neutral as measured at the Influence Points. At step 311, public opinion influencing engine creates an optimized series of campaigns to effectively and rapidly change the tone at the influence points. At step 312, community members participate in campaigns, voicing their opinions where needed or performing other actions requested by the public opinion influencing engine. As a result 313, Influence points either become positive, such as showing more favorable content than before, creating a shift in the public opinion 314.

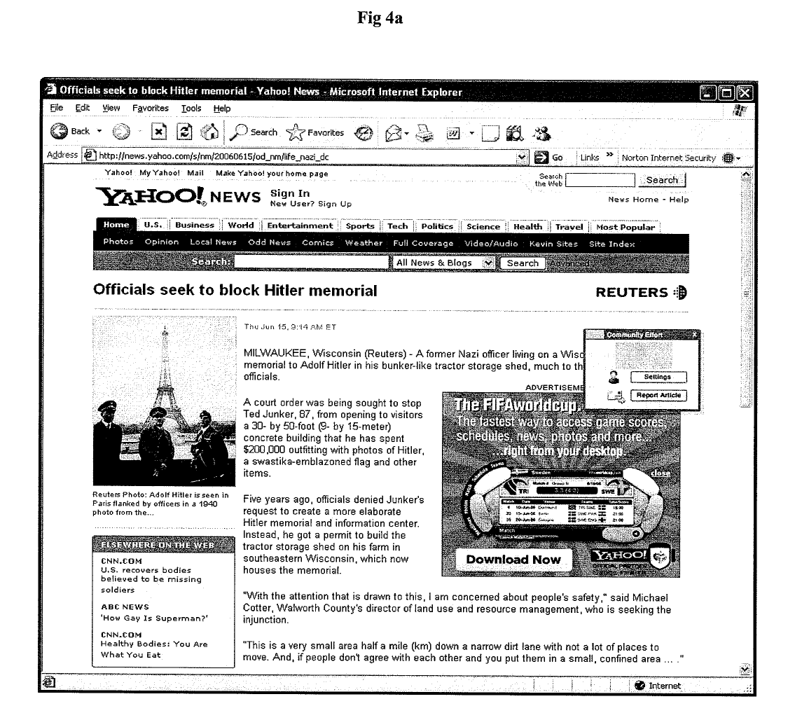

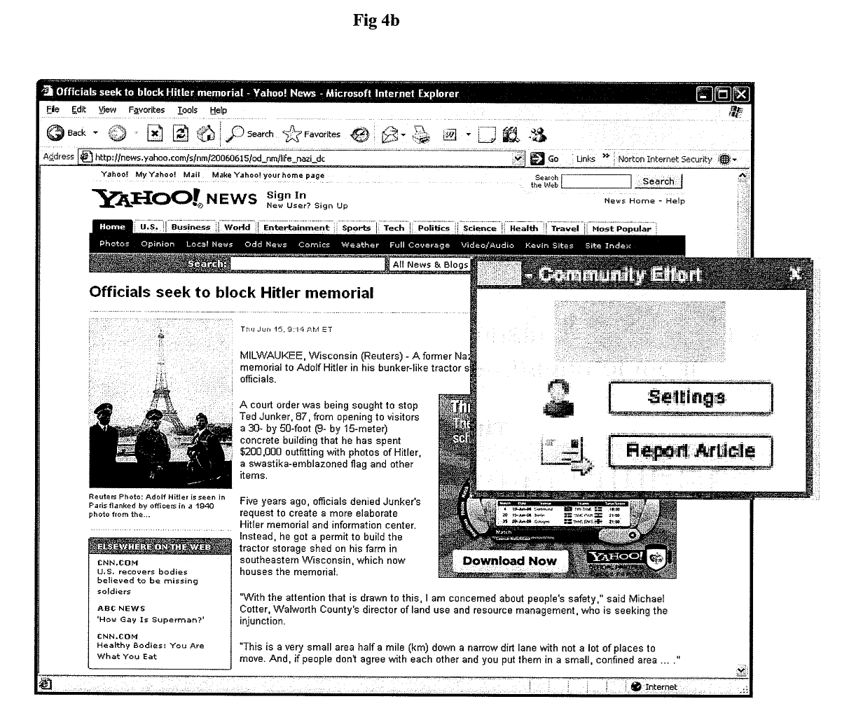

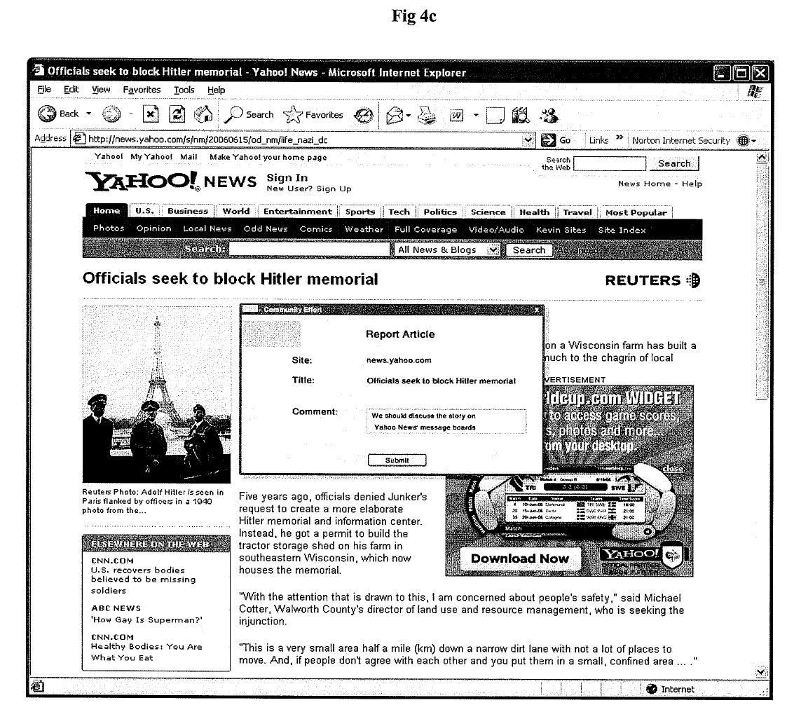

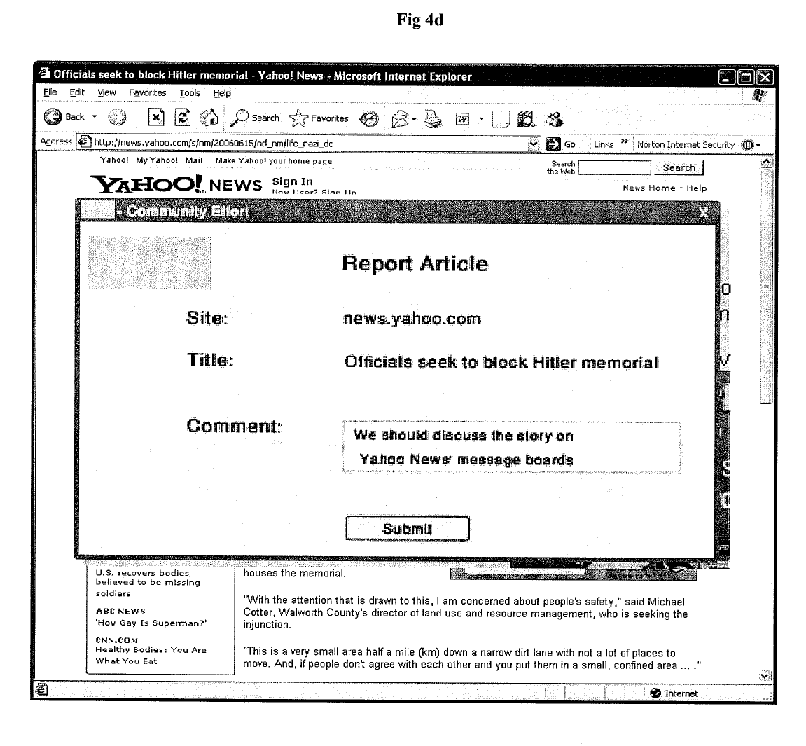

FIG. 4a-4d show an example of a community member 104 reporting a news article as a URL to Collector 210. In FIG. 4a the member clicks on “report article” button in an add-on to her browser. FIG. 4b shows the GUI of the add-on in greater details. The user is then promoted and her comment as shown in FIG. 4c and in greater details in FIG. 4d. The URL and the user's comments are sent to Collector 210. The add-on functionally may be performed by additional executable software instructions providing interactive programming operations as recognized by one having ordinary skill in the art.

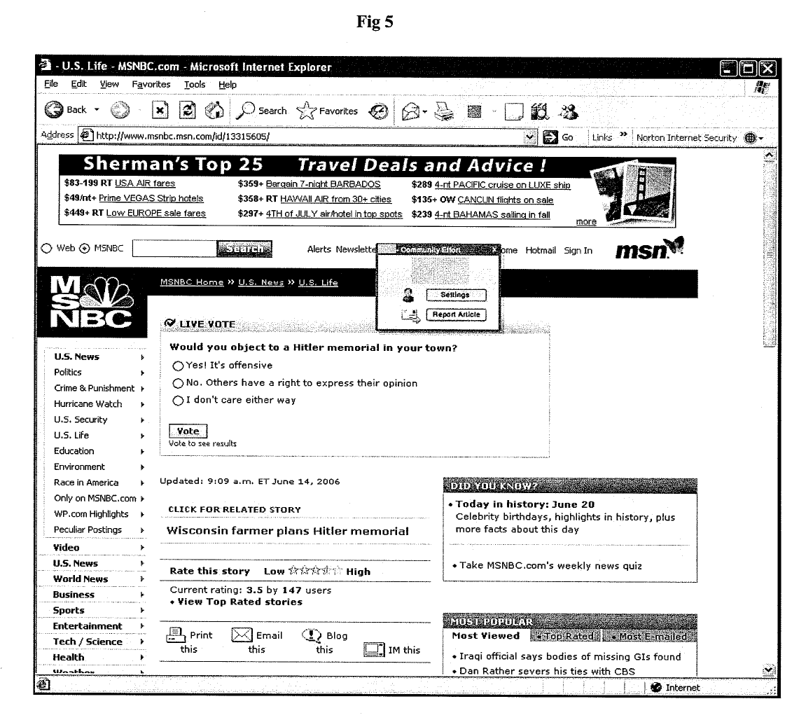

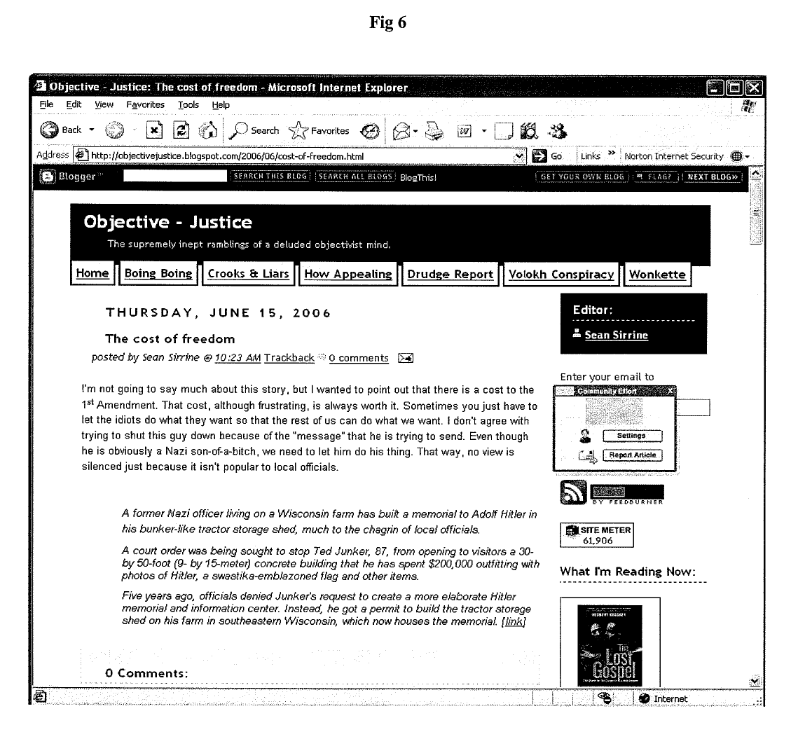

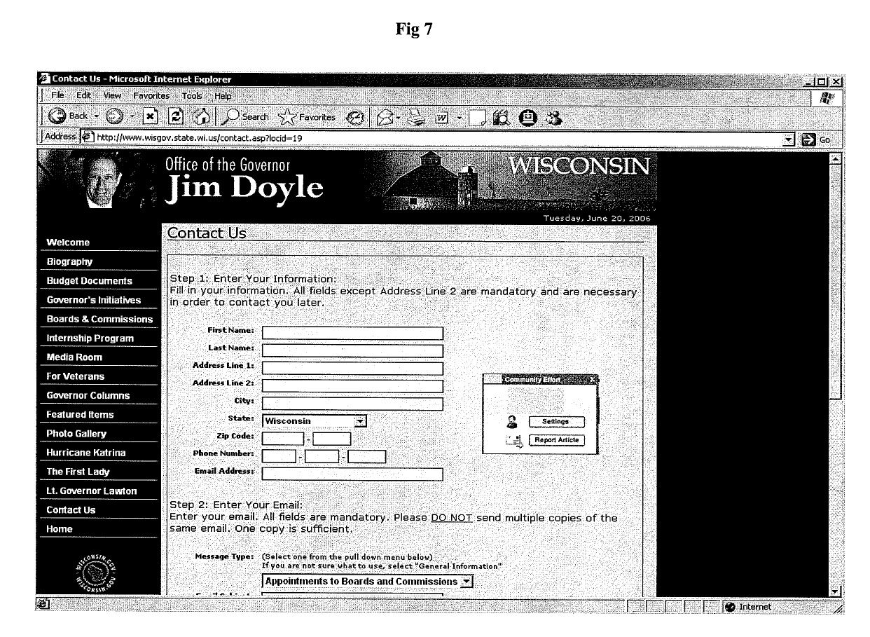

FIG. 5 illustrates example of a member reporting a survey using the same browser add-on shown in FIG. 4a-4d. FIG. 6 illustrates example of a member reporting a blog item and FIG. 7 illustrates example of a member reporting a political leader's site.

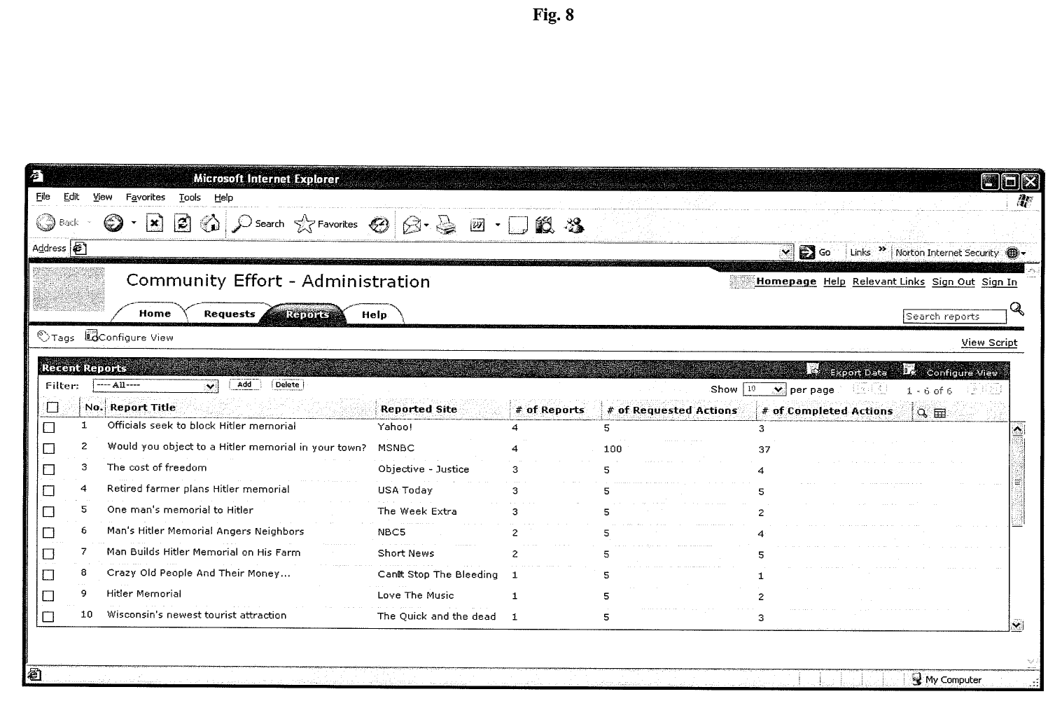

FIG. 8 illustrates example of one embodiment for a user interface for Planner 212. The human analyst can view URLs of Interest 203 and the number of actions requested and completed (as reported by Monitor 215) for each URL of Interest 203.

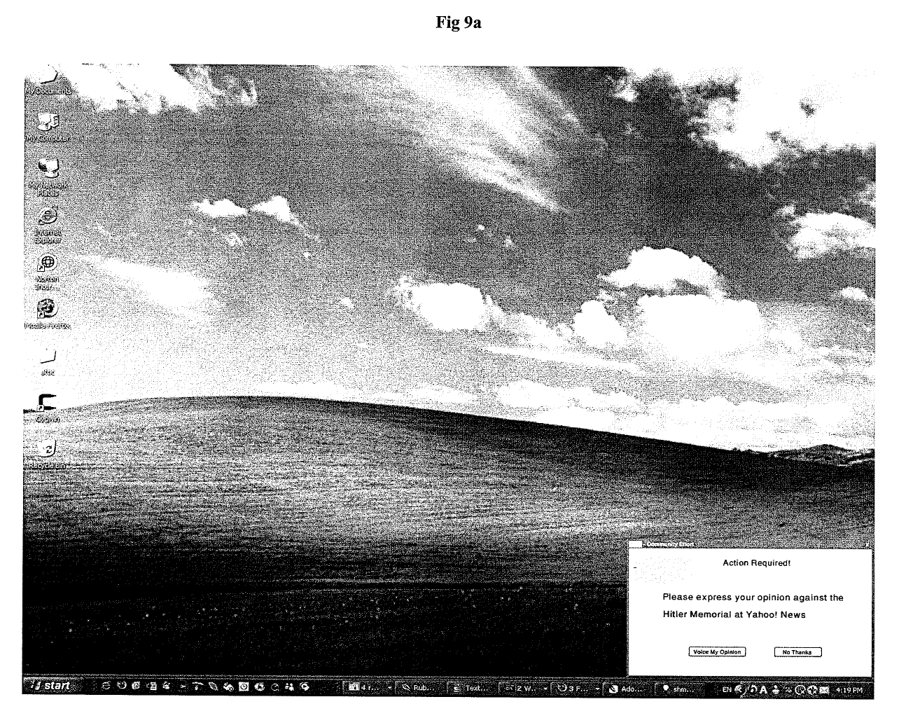

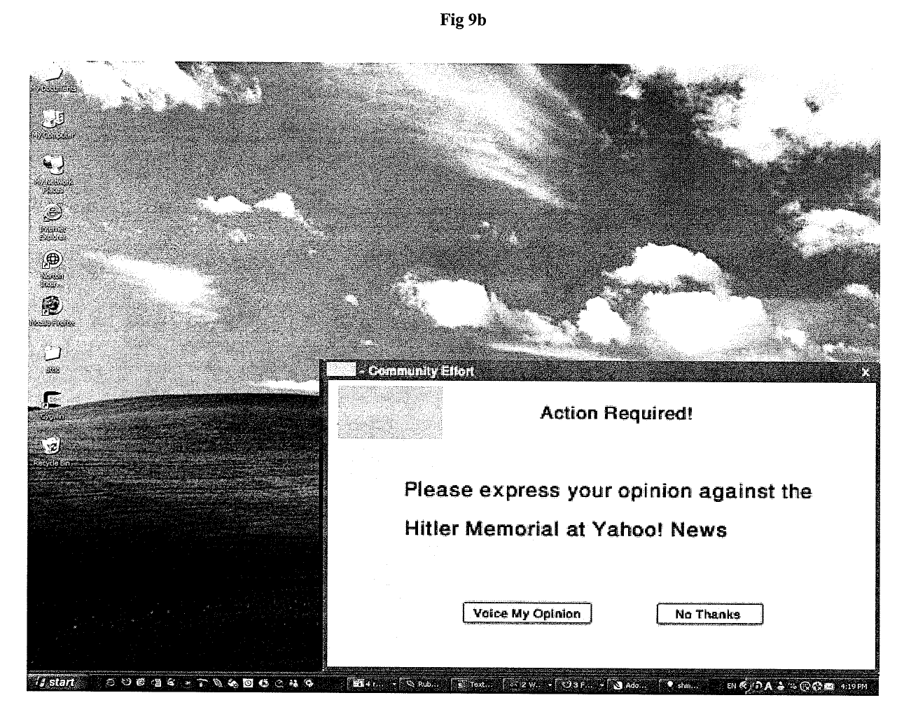

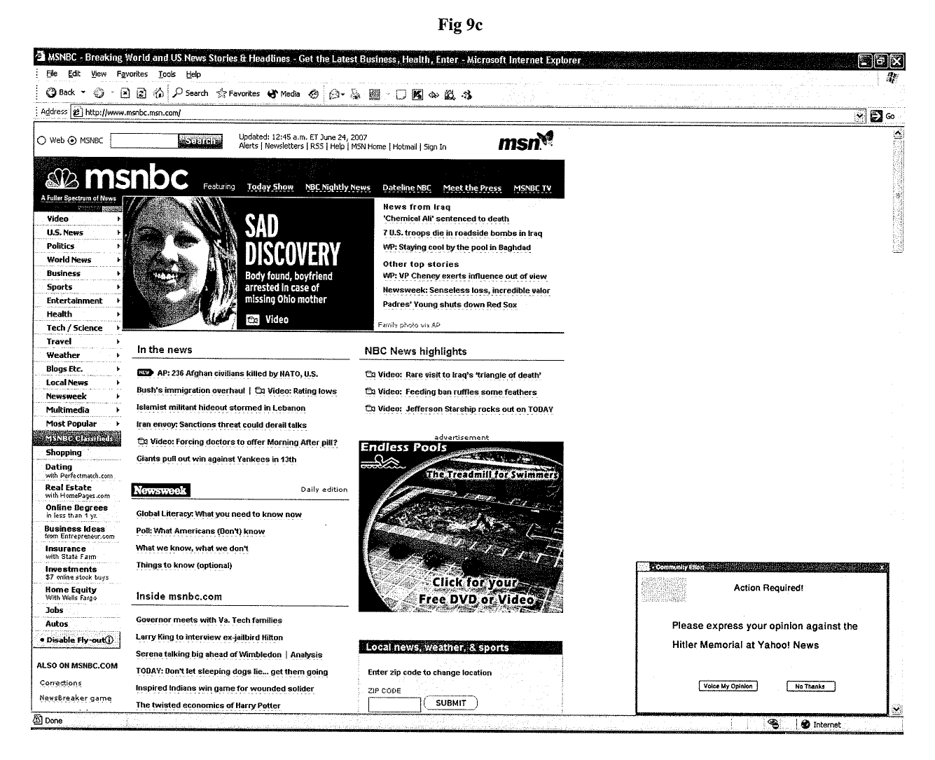

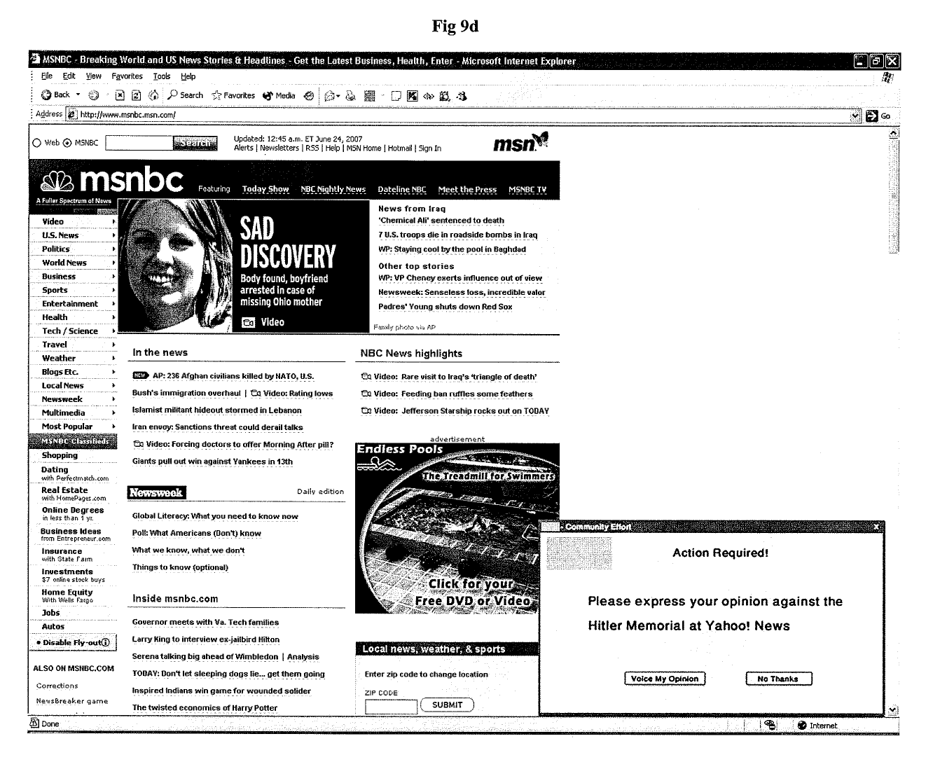

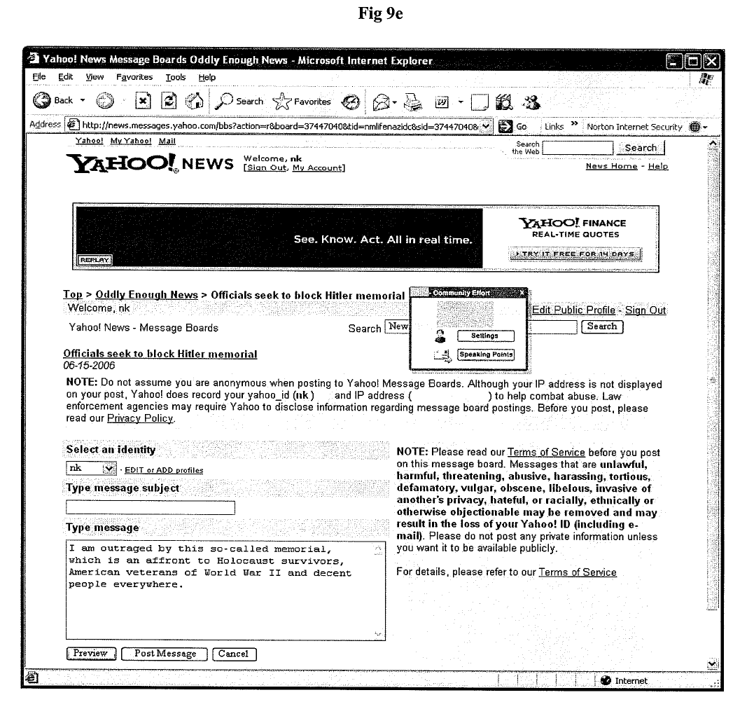

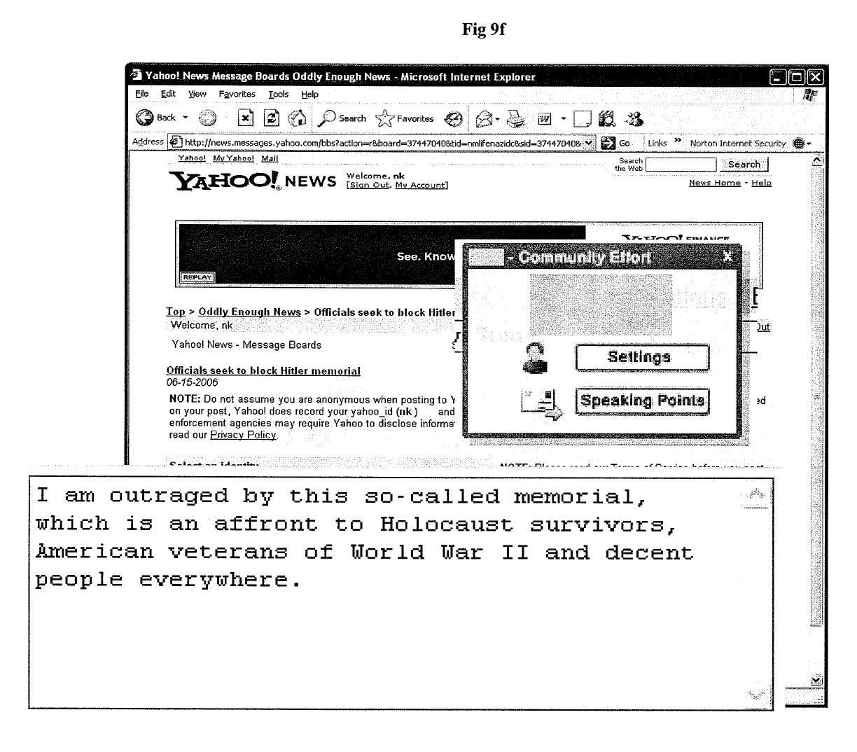

FIG. 9a-9f illustrate example of a user alerted to voice her opinion as part of a campaign via a desktop alert or browser add-on alert sent by Distributor 213. In FIG. 9a or FIG. 9c the member is asked to voice her opinion about an offensive article. FIG. 9b or FIG. 9d shows the GUI of the alert in greater details. When the user clicks on “voice my opinion” button, she is taken to the offensive article where she voices her opinion as shown in FIG. 9e (and in greater details in FIG. 9f.

System 100 can be offered to not for profit organizations, political parties and other organizations with a clear agenda and loyal supporters. It can be offered either as a managed service, on a subscription basis, or be offered free of charge to relevant organizations in exchange for their agreement to display highly targeted advertisement to community members. For example, advertisement may be displayed within the members' reporting tool.

Other business models and technical aspects are apparent to those skilled in the relevant art(s) in view of the teachings of the present disclosure. FIGS. 1-9 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (i.e., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by a processor to cause the processor to perform the functions of the invention as described herein. In this document, the terms “machine readable medium,” “computer program medium” and “computer usable medium” are used to generally refer to media such as a removable storage unit (e.g., a magnetic or optical disc, flash ROM, or the like), a hard disk, signals (i.e., electronic, electromagnetic, or optical signals), or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for influencing public opinion, the method comprising:
receiving a plurality of influence points relating to public opinion;
determining a plurality of URLs of interest (UOIs) based on the plurality of influence points;
determining an information distribution campaign including tasks relating to the UOIs; and
distributing the tasks to community members for execution of the information distribution campaign.

2. The method of claim 1 further comprising:
monitoring the information distribution campaign.

3. The method of claim 1, wherein monitoring the information distribution campaign includes directly contacting the UOIs.

4. The method of claim 2, wherein monitoring the information distribution campaign includes receiving status information from the community members.

5. The method of claim 4, where the status information is received via a script executing at a local processing device.

6. The method of claim 1, further comprising:
receiving influence points from community members.

7. The method of claim 1 further comprising:
receiving influence points from an automated data feed.

8. The method of claim 7, wherein the automated data feed includes at least one of: a really simply subscription (RSS) feed and a search engine query.

9. The method of claim 1, wherein determining the information distribution campaign includes prioritizing the UOIs.

10. The method of claim 9, wherein the prioritizing of the UOIs is performed using at least one of: an electronic operation and a manual operation.

11. The method of claim 1, wherein the information distribution campaign includes posting content that references the UOIs.

12. The method of claim 1, wherein the determination of the information distribution campaign includes:
analyzing each of the plurality of UOIs; and
determining at least one of a plurality of information distribution techniques for each of the plurality of UOIs.

13. The method of claim 1, wherein the determination of the information distribution campaign includes selecting a number of community members for participation in the campaign.

14. The method of claim 1, wherein the tasks of the information distribution campaign include electronically voicing opinions at at least one: the UOIs or an electronic location referencing the UOIs.

15. The method of claim 14, wherein the tasks generate a positive information trend, as measured by an outside agency.

16. The method of claim 14, wherein the electronic voicing opinions includes providing information about at least one real-life event.

17. The method of claim 1, wherein the tasks of the information distribution campaign include electronically voicing opinions at at least one of: web logs, newspapers, online review web sites, electronic messaging, and electronic discussion forums.

18. The method of claim 1, wherein the tasks of the information distribution campaign include electronically voicing opinions to at least one of: influential persons and organizations.

19. The method of claim 1, wherein the tasks of the information distribution campaign include member participation in at least one of a plurality of online surveys.

20. The method of claim 1, wherein the tasks of the information distribution campaign include electronic searches using electronic search engines for popularizing corresponding search terms.

21. The method of claim 1, wherein the tasks of the information distribution campaign include electronically downloading an application to popularize the application.

22. The method of claim 1, wherein the tasks of the information distribution campaign include electronically promoting an online article to popularize the article.

23. The method of claim 1, wherein the tasks of the information distribution campaign include instructions for a manual user activity, wherein the manual user activity includes at least one of: writing a letter, contacting a representative and attending a demonstration.

24. The method of claim 1 further comprising:
providing information to community members, wherein the information is usable for future information distribution campaigns.

25. The method of claim 1 further comprising:
distributing reminder data with the tasks; and
at predefined intervals, generating reminder alerts from the reminder data.

26. The method of claim 1 further comprising:
providing an automated script to a local computing device of one of the members; and
performing at least one portion of one of the tasks for the member, via the local computing device, on behalf of the member.

27. The method of claim 1 further comprising:
for each of the community members, receiving an assigned portion of the tasks at a local processing device.

28. The method of claim 1, wherein the influence points may include at least one of: a written article, a video, a photo and a web log.

29. The method of claim 1, wherein the influence points are generated by at least one of: community members and system users.

30. An apparatus for influencing public opinion, the apparatus comprising:
a memory device having executable instructions stored thereon; and
a processing device, in response to the executable instructions, operative to:
electronically receive a plurality of influence points relating to public opinion;
determine a plurality of URLs of interest (UOIs) based on the plurality of influence points;
determine an information distribution campaign including tasks relating to the UOIs; and
distribute the tasks to community members for execution of the information distribution campaign.

31. The apparatus of claim 30, wherein the processing device, in response to the executable instructions, is further operative to:
monitor the information distribution campaign.

32. The apparatus of claim 31, wherein monitoring the information distribution campaign includes directly contacting the UOIs.

33. The apparatus of claim 31, wherein monitoring the information distribution campaign includes receiving status information from the community members.

34. The apparatus of claim 31, where the status information is received via a script executing a local processing device.

35. The apparatus of claim 30, wherein the processing device, in response to the executable instructions, is further operative to:
receive influence points from at least one of: community members and an automated data feed.

36. The apparatus of claim 30, wherein determining the information distribution campaign includes prioritizing the UOIs and wherein the prioritizing of the UOIs is performed using at least one of: an electronic operation and a manual operation.

37. The apparatus of claim 30, wherein the information distribution campaign includes posting content that references the UOIs.

38. The apparatus of claim 30, wherein the determination of the information distribution campaign, as executed by the processing device, includes:
analyzing each of the plurality of UOIs; and
determining at least one of a plurality of information distribution techniques for each of the plurality of UOIs.

39. The apparatus of claim 30, wherein the determination of the information distribution campaign includes selecting a number of community members for participation in the campaign.

40. The apparatus of claim 30, wherein the tasks of the information distribution campaign include electronically voicing opinions at at least one: the UOIs, an electronic location referencing the UOIs, web logs, newspapers, online review web sites and electronic discussion forums.

41. The apparatus of claim 40, wherein the tasks generate a positive information trend, as measured by an outside agency.

42. The apparatus of claim 40, wherein the electronic voicing opinions includes providing information about at least one real-life event.

43. The apparatus of claim 30, wherein the tasks of the information distribution campaign include electronically voicing opinions to at least one of: influential persons and organizations.

44. The apparatus of claim 30, wherein the tasks of the information distribution campaign include at least one of: member participation in at least one of a plurality of online surveys, electronic searches using electronic search engines for popularizing corresponding search terms, electronically downloading an application to popularize the application, electronically promoting an online article to popularize the article and instructions for a manual user activity.

45. The apparatus of claim 30, wherein the processing device, in response to the executable instructions, is further operative to:
provide information to community members, wherein the information is usable for future information distribution campaigns.

46. The apparatus of claim 30, wherein the processing device, in response to the executable instructions, is further operative to:
distribute reminder data with the tasks; and
at predefined intervals, generate reminder alerts from the reminder data.

47. The apparatus of claim 30, wherein the processing device, in response to the executable instructions, is further operative to:
provide an automated script to a local computing device of one of the members; and
perform at least one portion of one of the tasks for the member, via the local computing device, on behalf of the member.

48. The apparatus of claim 30, wherein the influence points may include at least one of: a written article, a video, a photo and a web log.

49. The apparatus of claim 30, wherein the influence points are generated by at least one of: community members and system users.
